(19) United States
(12) Patent Application Publication
(10) Pub. No.: US 2026/0316316 A1
(43) Pub. Date: Oct. 15, 2026

(54) APPARATUS AND METHOD FOR CUTTING AND CLEANING ELONGATED FOOD PRODUCTS UTILIZING A FLUID VORTEX

(71) Applicant: Heat and Control, Inc., Hayward, CA (US)

(72) Inventors: Andrew Anthony Caridis, San Carlos, CA (US); Miguel Angel Gomez Angulo, Zapopan (MX); Jhonatan Monroy Oropeza, Guadalajara (MX); Leopoldo Zarate Andrade, Tlajomulco de Zuniga (MX)

(73) Assignee: Heat and Control, Inc., Hayward, CA (US)

(21) Appl. No.: 18/998,844

(22) PCT Filed: Jul. 27, 2023
(86) PCT No.: PCT/IB2023/057655

§ 371 Date: Jan. 27, 2025

(30) Foreign Application Priority Data
Jul. 28, 2022 (MX) MX/A/2022/009316

(51) Int. Cl. B26D 7/06; B04C 3/00; B04C 9/00; B08B 3/10; B26D 7/08; B26D 7/32

(52) U.S. Cl. CPC B26D 7/0658; B04C 3/00; B08B 3/102; B26D 7/088; B26D 7/32; B04C 2009/008; B26D 2210/02

(57) ABSTRACT

A method of cutting a generally elongated food product comprising creating a fluid vortex in a container, the vortex having an axis substantially centered on the outlet of the container. The generally elongated food product is deposited into the container. The fluid vortex aligns the generally elongated food product with the axis of the vortex and directs the generally elongated food product into the outlet to a product slicing element to form a plurality of sliced products. An apparatus for cutting a generally elongated food product and a method for washing a food product in a first container, slicing the food product to form a plurality of sliced products and washing the sliced products in a second container are provided.

### FIELD OF THE INVENTION

The present invention generally relates to cutting food products, and particularly to cutting food products with a generally elongated shape.

### BACKGROUND OF THE INVENTION

Apparatus and methods for cutting products, particularly food products in the field of food processing, are known in the art. For example, various types of food products are cut and even pretreated before being transformed by a thermal process such as frying or baking for final sale to a consumer.

It is known that various fruits and vegetables, for example potatoes, carrots, onions, squash, sweet potatoes and bananas, contain surface substances, such as starch or latex, which can detract from the flavor of the food product when it is processed for final consumption, for example in a fryer or dehydrator. The removal of latex from food products can be important because a certain percentage of consumers experience allergic reactions to it. The presence of latex can also be undesirable during the processing of a food product. For example, conveyor belts can accumulate latex while transporting freshly cut products. Cleaning latex from conveyor belts can be laborious and time consuming. The accumulation of latex on frying equipment can damage and reduce the useful life of the equipment. With respect to bananas, latex is found in all parts of the plant. When the latex is fresh and fluid it can be washed, but in a few hours it can become sticky and turn into a dark spot on the skin of the fruit, causing a decrease in the quality of the food product utilizing the fruit. The process of washing fruits and vegetables, for example plantains, with water to remove latex is known, but often requires an additional liquid specially formulated to remove fresh latex from the fruit or vegetable. For example, BANASPAR-S® is often used in the post-harvest washing process for bananas and plantains for inhibiting staining or premature ripening.

Equipment for automatically and continuously washing food products are known. For example, U.S. Pat. No. 6,413,566 discloses a slicing process for relatively firm vegetables or fruit that includes feeding of the vegetables or fruit through a vertical conveyor and guiding them to a centrifugal slicing device to provide slices of the vegetables or fruit that are discharged into water. US 20020122859 discloses a food processing system that transports food in a fluid medium to a processing that includes a tool for performing a processing operation on the food, such as cutting potatoes into sticks for French fries. KR 20060134943 discloses a food processing system for dividing a food stream into a plurality of streams for conveying conveying food to multiple slicers, washing the food slices, transporting the slices and distributing the slices onto a conveyor for further processing. US 20150135926 discloses a rotatably drivable cutting blade for machines for slicing food products.

Notwithstanding the different alternatives mentioned above, there is a need for additional effective, flexible and economical solutions for cutting, washing or both cutting and washing products such as food products.

### BRIEF DESCRIPTION OF THE FIGURES

The drawings described herein are for illustration purposes only and are not intended to limit the scope of the present disclosure in any way.

FIG. 1 is a side view of an embodiment of an apparatus of the invention, in a vertical configuration, for cutting and washing products, for example elongated food products.

FIG. 2 is a right front top perspective view of the apparatus of FIG. 1.

FIG. 3 is a right rear perspective view of the apparatus of FIG. 1.

FIG. 4 is a right front top perspective view of an embodiment of the upper section of the apparatus of FIG. 1.

FIG. 5 is a front view of the upper section of FIG. 4.

FIG. 6 is a right-side view of the upper section of FIG. 4.

FIG. 7 is a left side cross-sectional view of the upper section of FIG. 4.

FIG. 8 is a perspective view of a portion of the upper section of FIG. 4 showing fluid inlets to the container for creating swirling fluid in the container.

FIG. 9 is a top plan view of the portion of the upper section shown in FIG. 8 taken along the line 9 -9 in FIG. 8.

FIG. 10 is an enlarged view of a portion of the cross-sectional view of FIG. 7.

FIG. 11 is schematic illustration of an embodiment for forming a fluid vortex of the present invention to facilitate cutting of products by the apparatus of the invention.

FIG. 12 is a lower right perspective view of the upper section of FIG. 4 showing an embodiment of the cutting module or elements of the apparatus of the invention.

FIG. 13 is a right front top perspective view of an embodiment of the washing portion of the apparatus of the invention.

FIG. 14 is a left-side view of the washing portion of FIG. 13.

FIG. 15 is a right-side view of the washing portion of FIG. 13.

FIG. 16 is a right front top perspective view of an embodiment of the filtering portion of the apparatus of the invention.

FIG. 17 is a top view of the filtering portion of FIG. 16.

FIG. 18 is a schematic illustration showing the flow direction in an embodiment of the slicing and washing process of the invention.

FIG. 19 is a block diagram illustrating the process flow of an embodiment of the present invention with a horizontal configuration and a flow towards the right.

FIG. 20 is a block diagram illustrating the process flow of an embodiment of the present invention with a downward sloping configuration.

FIG. 21 is a block diagram illustrating the process flow of an embodiment of the present invention with a vertical upward configuration.

### DETAILED DESCRIPTION OF THE INVENTION

An apparatus and method for cutting products of a generally elongated shape is provided. The product can be of any suitable type, and can optionally be a food product. The food products can optionally have a generally elongated shape and optionally be called generally elongated food products. The food products can optionally be fruits and vegetables. Examples of fruits or vegetables with a generally elongated shape include bananas, cucumbers, squash, carrots, cassava, sweet potato, malanga and taro.

The apparatus and method of the invention can optionally align an elongated product, for example an elongated food product or food product with an elongated shape, with an entrance to a cutting or slicing device. The apparatus and method can optionally provide a fluid, for example a liquid, formed in any suitable manner to carry or direct the elongated product into alignment with the entrance to the cutting or slicing device. The fluid can optionally be a washing fluid or washing liquid. The fluid can optionally align the elongated product along its axis, which can be referred to as its elongate axis, as the product enters the cutting or slicing device. The aligned axis can optionally be centered on the outlet. The aligned axis can optionally be substantially perpendicular to the cutting or slicing element. The fluid can optionally be referred to or described as a swirling or whirling fluid. The fluid can optionally be referred to or described as a vortex. The swirling or whirling fluid or vortex can have an axis. The axis can optionally be substantially centered on or aligned with the outlet. The swirling or whirling fluid or vortex can optionally taper inwardly as it approaches the cutting or slicing element. The swirling or whirling fluid, or vortex, can optionally have a diameter or transverse dimension that reduces as the fluid approaches the entrance to the cutting or slicing element. A thrust ring of water, for example having the shape of an inclined curtain, can optionally be included to provide greater push force to the fluid towards the cutting or slicing element, and stability of the geometry of the turbulence inside of the chamber for positioning and slicing the product.

The fluid can optionally be carried within a container having an outlet that communicates or exits to the cutting or slicing device. The container can optionally be referred to as a feed container, a module, a vessel, a tank, a hopper or any combination of the foregoing. The container can optionally be cylindrical in shape. The container can optionally taper or narrow inwardly towards its outlet. The container can optionally have a conical portion that tapers or narrows inwardly towards the outlet of the container. The fluid can optionally swirl or whirl or form a vortex within a cylindrical container. The fluid can optionally swirl or whirl with a cylindrical container that narrows the diameter of the swirling or whirling fluid as the fluid approaches the outlet of the container. The cylindrical container can optionally taper or narrow inwardly towards the outlet for facilitating the tapering or narrowing of the swirling or whirling fluid or vortex. The swirling or whirling fluid or vortex can have an axis substantially coaxial with, or centered on, the outlet of the container.

The swirling or whirling of the fluid, or the vortex, within the container can be created in any suitable manner. For example, pressurized or high velocity fluid can optionally be introduced into the container in any suitable manner to form the swirling or whirling fluid or vortex. The pressurized or high velocity fluid can optionally be created by means of pumps. The pressurized fluid can optionally be in the form of one or more jets of fluid. The pressurized or high velocity fluid can optionally be introduced or directed, for example by means of one or more jet ports, along the inside of the outer wall of the container for swirling or whirling the fluid within the container.

The container can optionally have a plurality of fluid or liquid jet ports, or pressurized fluid inlet ports, spaced around its periphery for forming the whirling or swirling fluid or vortex within the container. The pressurized or high velocity fluid, for example jets, can optionally be introduced or directed into the cylindrical container, for example by means of jet or fluid ports, substantially perpendicular to the radius or diameter of the container. The pressurized fluid or high velocity fluid can optionally be introduced into the cylindrical container tangentially to the cylinder. As the water level in the container increases due to accumulation, the volume of fluid or water can begin to rotate until it generates the vortex or swirling or whirling fluid to favor the subsequent slicing process. The pressurized or high velocity fluid, for example jets, can optionally be directed towards the outlet of the container.

The method and apparatus of the invention can optionally include washing a food product in a first container in a first washing step, with or without the washing fluid be swirling or whirling or being a vortex in the first container, slicing the food product to form a plurality of sliced products and washing the sliced products in a second container in a second washing step. When the first washing step includes a swirling or whirling fluid or vortex, such fluid can optionally rotate, twist or otherwise periodically or constantly change the position of the food product while in the fluid to facilitate cleaning of the food product. The second washing step can optionally include immersing the plurality of sliced products in the second container. The washing steps of the invention avoid the use of chemical additives typically used to remove superficial substances, such as latex and starch, from a food product.

The method and apparatus of the invention can optionally include a feed and slicing module, an optional tank module, an optional filtering module or any combination of the foregoing. The feed and slicing module can optionally include a hopper, tank, container or vessel inside of which an optional vortex, or swirling or whirling fluid, is formed that positions and pushes the product to be sliced towards a slicing element where it will be cut . The axis of the food product can optionally be substantially centered on the outlet of the container, and optionally the slicing element, as the product approaches the slicing element. The swirling or whirling fluid or vortex can optionally taper inwardly as it approaches the cutting or slicing element, for example for facilitating alignment of the axis of the food product with the container outlet and optionally the slicing element. The feed and slicing module can optionally start the washing of the product to be cut. Inside the optional vortex or swirling or whirling fluid the product constantly changes position, for example from vertical to horizontal and vice versa, until it reaches a region where it is substantially aligned with the axis of the fluid before entering the slicing element. The optional tank module can comprise a main tank to contain a fluid suitable for providing additional washing to the washed and cut product coming from the feed and slicing module. The optional filtering module can comprise a plurality of separation tanks and filters to filter the fluid, for example loaded with solid waste from the washing process, and recirculate it to the system.

The figures herein illustrate an embodiment of the method and apparatus of the invention for cutting bananas. It is appreciated that the method and apparatus of the invention can be used with any food or other product, for example any product that has a generally elongated shape. Suitable food products include cucumbers, squash, carrots, cassava, sweet potato, malanga and taro, among others.

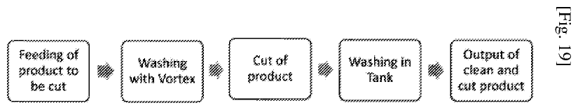

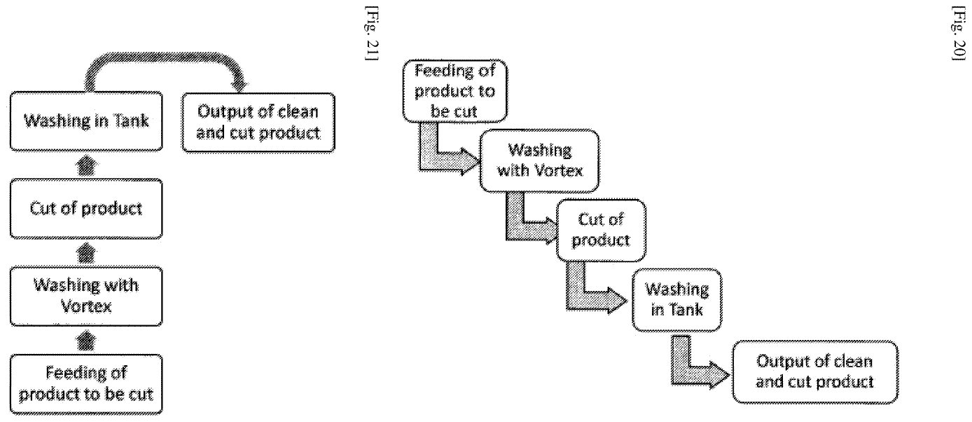

The figures herein illustrate an embodiment of the method and apparatus of the invention that presents a vertical configuration with downward flow, for example the feeding of the products to be cut is carried out through the upper part of the apparatus while the outlet and the tub in which the washed product is located in the lower part of the apparatus. It is that the configuration, for example direction of flow, can be modified without affecting the essence of the invention. For example, other configurations can be provided, for example vertical with upward flow (feeding from the bottom and outlet/washing at the top), horizontal with flow to the right or left (feed and outlet/washing along the same horizontal line, sloping with downward flow (feed at the top and outlet/washing at the bottom), sloping with upward flow (feed at the bottom and outlet/washing at the top). Some of configurations have been illustrated by means of block diagrams in FIGS. 19-21.

The term “a plurality” as used herein can optionally refer to any plurality, including a number ranging from 2 to 20. The term “at least” as used can optionally refer to a minimum value or lower limit for the element to which it refers. The terms “superficial substances”, “solid waste or residues” and “suspended solids” are used interchangeably herein and refer to the particles that are detached from the products to be cut and that are transferred to the washing fluid.

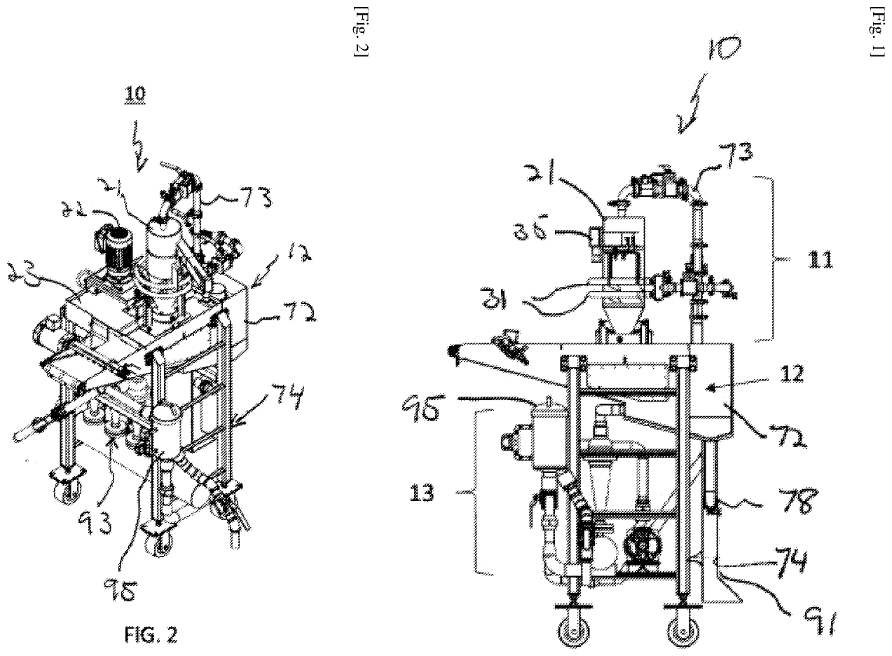

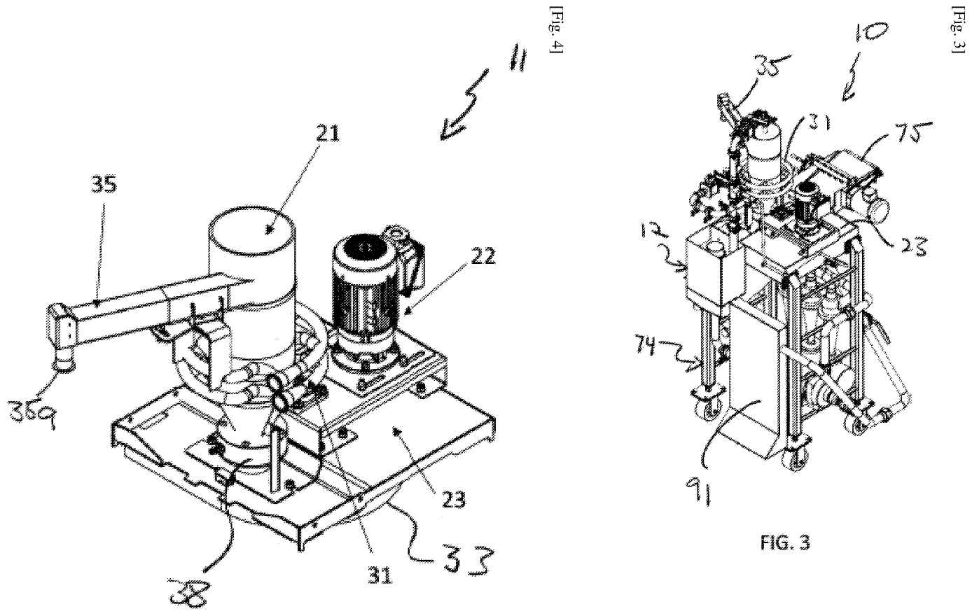

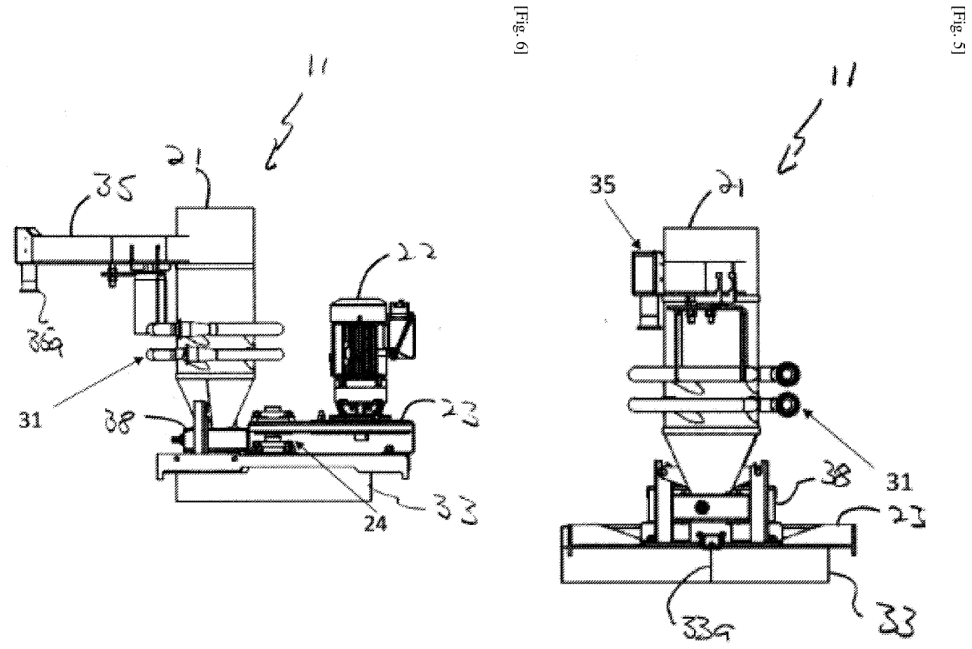

The apparatus of the invention can be of any suitable type. For example, apparatus 10 illustrated herein comprises a feed and slicing module 11, an optional tank module 12 and an optional filtering module 13 (see FIGS. 1-3).

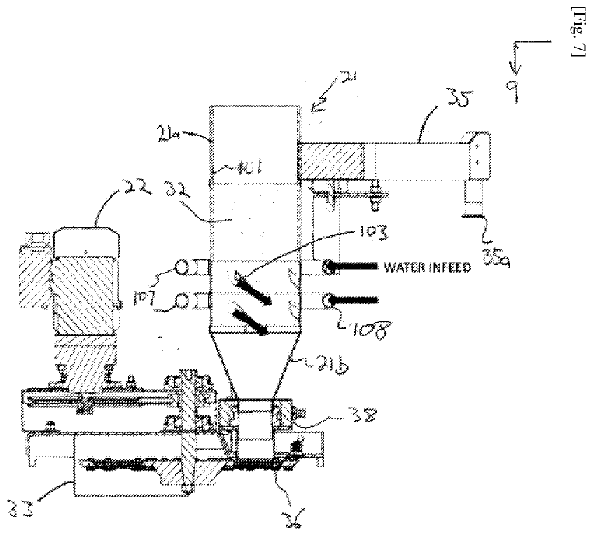

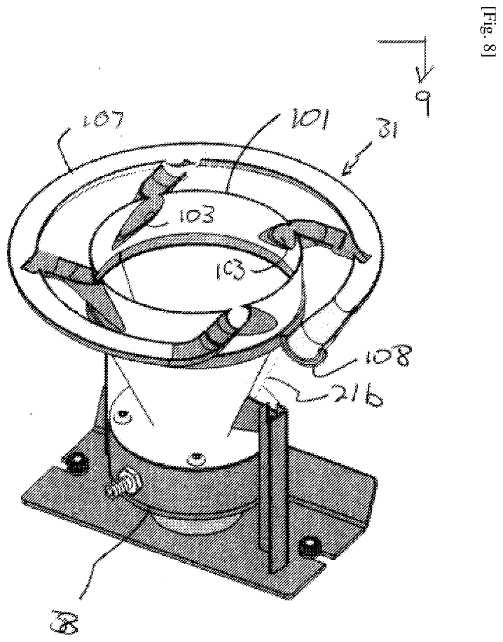

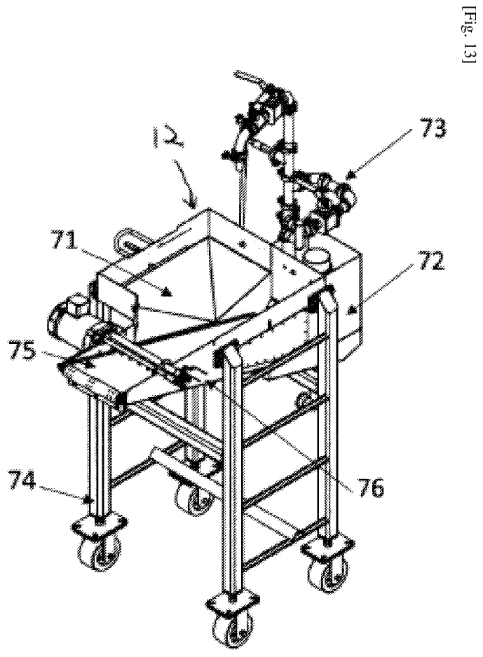

The feed and slicing module 11 can optionally comprise a container 21, which can optionally be referred to as a vessel, tank or hopper, which is optionally coupled at one end to a feed channel 35 through which the product to be sliced 41 will be fed. The feed and slicing module 11 can optionally comprise a slicing element 36, for example coupled to another end of the hopper 21 by means of a base 23 (see FIGS. 4-7 and 12). The coupling of the base 23 with the slicing element 36 can optionally be carried out by means of coupling means 24 (see FIG. 6), for example bearings and shafts, but the person skilled in the art will understand that other elements known in the art can be used for this purpose. A drive means 22 (see FIG. 4, 6-7 and 12) can be provided for providing movement to the slicing element 36. The drive means can optionally be coupled to a transmission system comprising pulleys and a belt (not shown) to transmit movement to the slicing element 36. The drive means 22 can optionally comprise an electric motor of any suitable type known in the state of the art.

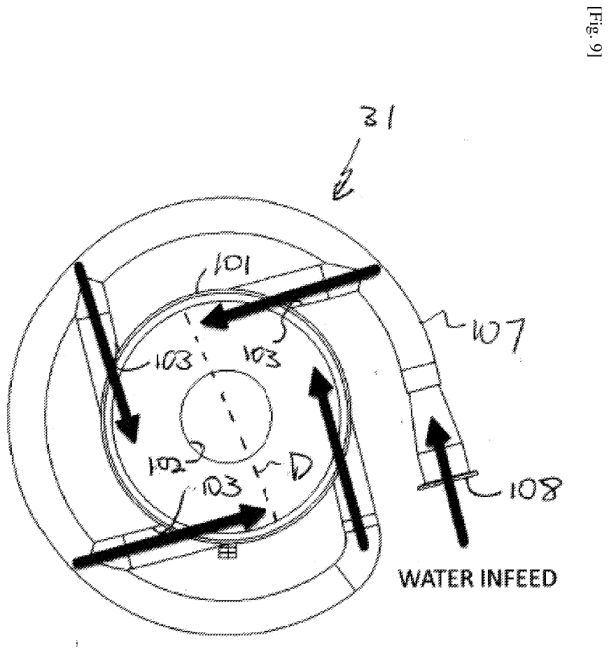

To assist in washing of the product 41 before being cut, which can optionally be referred to as a first washing, apparatus 10 can optionally include a washing fluid distribution module 73 comprising a plurality of pipes connected to one or more conduction means 31. The pipes of the distribution module (73) distribute the flow of the washing fluid at one or more points, for example a first point in the feed channel 35, for example at inlet 35a of the feed channel, to help push the product 41 towards the hopper 21 where it will be washed, a second point at the entrance to the hopper 21 and in the direction of the slicing element 36 to drive the product 41 towards said element while it is being washed, and a third point inside the hopper 21, where a vortex or swirling or whirling liquid 32 will be formed (FIG. 7). The inlets of container for introducing washing fluid to the container can optionally be referred to as washing fluid inlet ports.

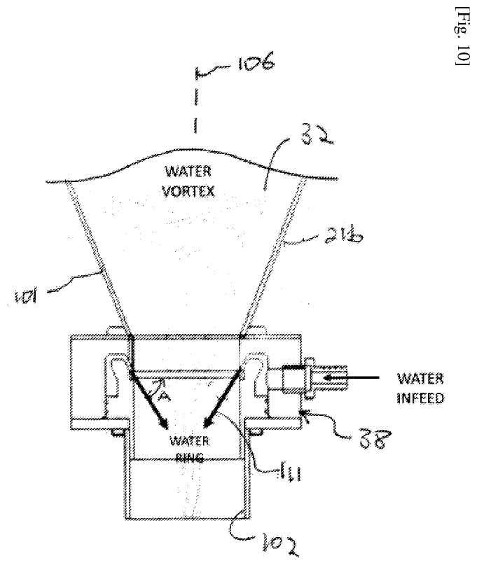

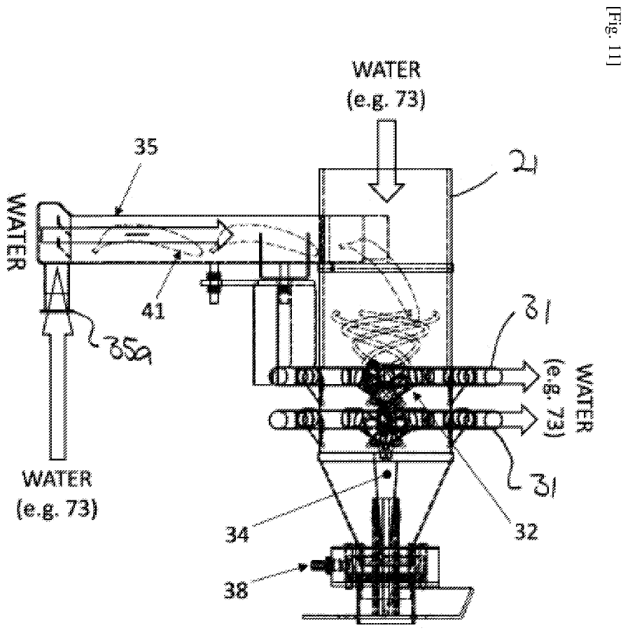

The container of the invention, for example hopper 21, can optionally be cylindrical in shape, for example a cylinder, having a periphery formed by a cylindrical wall 101 (see FIGS. 7-10). The container can optionally have a first or upper portion 21a and a second or lower port 21b. A portion of the container, for example second portion 21b, can taper inwardly toward an outlet 102 of the container. Such tapered portion of the container can optionally be referred to as a conical portion of the container 21. The container 21 can optionally have a plurality of fluid, liquid or water jet ports 103, which can be referred to as pressurized fluid ports or inlet ports, spaced around its periphery for forming the fluid vortex or swirling or whirling fluid 32 in the container. The container has a diameter, shown by the letter D in FIG. 9, and the plurality of fluid jet ports 103 are each optionally directed substantially perpendicular to the diameter of the container. The pressurized fluid or high velocity fluid can optionally be introduced into the cylindrical container 21 tangentially to the cylinder. As the water level in the container 21 increases due to accumulation, the volume of fluid or water can begin to rotate until it generates the vortex or swirling or whirling fluid 32 to favor the subsequent slicing process. The plurality of fluid jet ports 103 can each optionally be directed towards the outlet 102 of the container (see FIG. 8). More than one set of a plurality of jet ports 103 can optionally be provided in the container 21, for example with a first set spaced longitudinally apart from a second set on the axis of the cylindrical or other shaped container 21 (see FIG. 7). The conduction means 31 for providing fluid to jet ports 103 can optionally include a plurality of pipes 107 having respective inlets 108 coupled to any suitable fluid source, for example fluid distribution pipes or module 73. The feed channel 35 can optionally have an inlet port (not shown) within container 21 similar to fluid, liquid or water jet ports 103 for enhancing the formation of vortex 32.

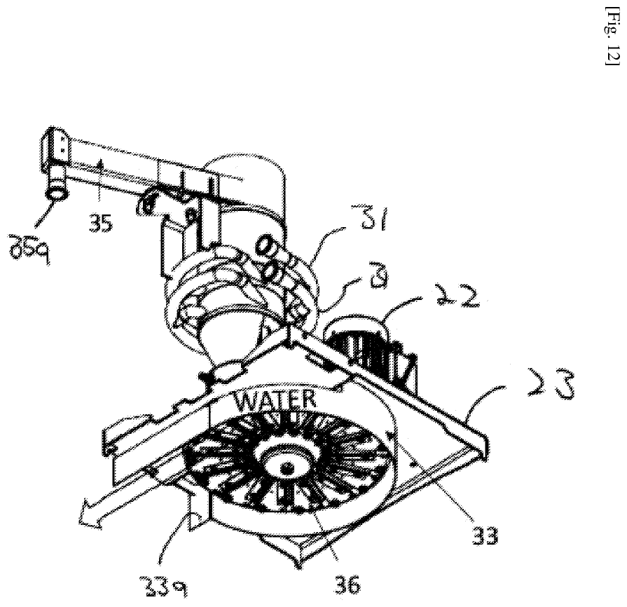

The swirling or whirling fluid or vortex 32 can have an axis 106 (see FIG. 10). Axis 106 can optionally be substantially coaxial with the outlet 102 of the container 21. The fluid vortex or swirling or whirling fluid 32 can optionally align generally elongated food or other product with the axis 106 of the vortex and direct the generally elongated food product into the outlet 102 to the product slicing element 36 to form a plurality of sliced products from the food product.

Apparatus 10 can optionally be provided with at least one thrust ring 38 to generate a fluid ring 111 for directing the product 41 towards the slicing element 36 (see FIG. 10). The fluid ring is optionally a cylindrical wall or inclined curtain of fluid that narrows the periphery of the vortex or swirling or whirling fluid as it travels towards the outlet 102 of the container. The fluid ring 111 can optionally be in a direction of the tangential flow of the vortex 32, for example at an angle A of inclination that can optionally range from 45° and 80° or optionally 60°. A thrust ring 38 can optionally be provided that permits the angle A of inclination of the fluid ring 111 to be selectively changed by the operator. The thrust ring can provide greater push force to the fluid in container 21, including vortex 32, towards the cutting or slicing element 36, and stability of the geometry of the turbulence inside of the chamber for positioning and slicing the product 41.

The optional vertical-downwards inclination of apparatus 10, illustrated in the figures, moves product 41 downwardly under the force of gravity and with the help of the fluid within container 21 in the direction of the slicing element 36. It is appreciated that with other configurations, for example vertical ascending or horizontal rightwards or leftwards flow, the method and apparatus of the invention can be provided with additional transport elements of any suitable type, for example conveyor belts or pumps, to drive the product 41 towards the slicing element 36.

Slicing element 36 can be of any suitable type. The slicing element can optionally comprise a disc known in the art, for example those sold by the manufacturer URSCHEL®. The slicing element 36 can optionally be provided with a deflector 33 having an outlet 33a to direct the sliced product in a desired manner and direction, for example towards an output conveyor 75.

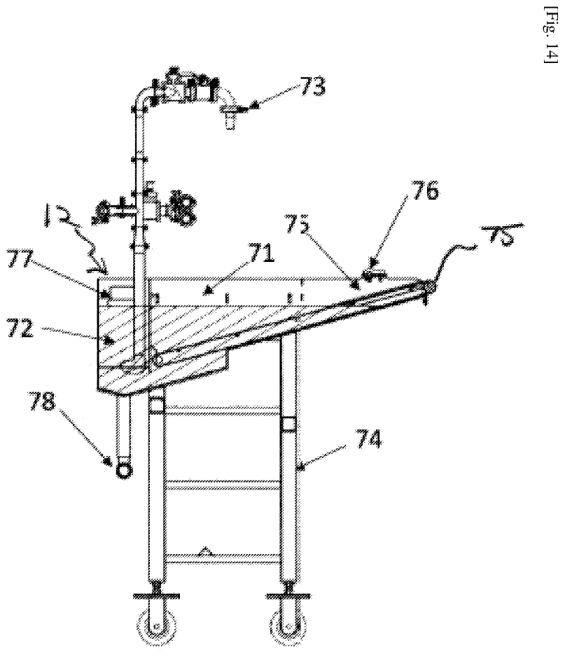

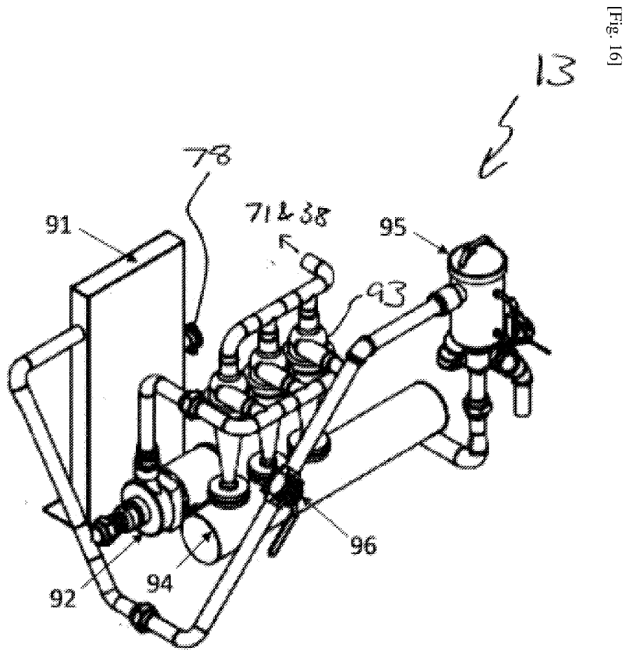

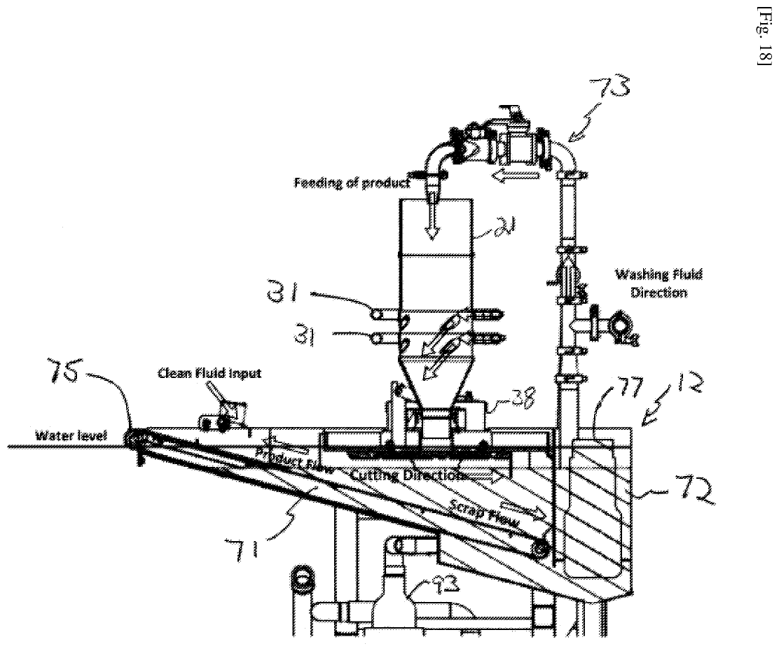

Tank module 12 can optionally comprise a main tank 71, for example arranged to be adjacent to the slicing element 36 (see FIGS. 13-15 and 18), to receive the sliced products and optionally carry out a second washing process and an optional secondary tank 72 to distribute the fluid throughout the system. Main tank 71 can contain any fluid suitable for washing the sliced products, for example fresh water or oil, and it will be the person skilled in the art who will determine the nature of said fluid according to the desired purpose and the type of product being processed by the apparatus 10. Once the product 41 is cut in the slicing element 36, it can be directed towards the main tank 71 with the help of the eccentric force with which it is expelled from the slicing element 36 and the flow of the washing fluid. Subsequently, it can be directed to the output conveyor 75 with the help of the deflector 33. As can be seen in FIG. 18, the level of the washing fluid in the main tank 71 can optionally be above the slicing element 36 to facilitate the transport and washing of the product 41 in the tank 71.

For food products such as fruits and vegetables, the tank 71 can optionally contain fresh water to wash them at the same time they are cut, as they may contain undesirable surface substances such as starch or latex. Tank 71 can optionally contain oil at room temperature. Oil may advantageously be used in an additional way when the cut product is to be cooked later, for example inside a fryer, since after the cutting step the product can optionally be introduced directly into the fryer. When cutting is done in water, a step prior to frying may be needed in which all the water evaporates so that it does not enter the fryer and cause damage. In addition to washing surface substances from the product 41, both water and oil may optionally prevent the product 41 from caking up as the product leaves the slicing element 36 in the form of slices.

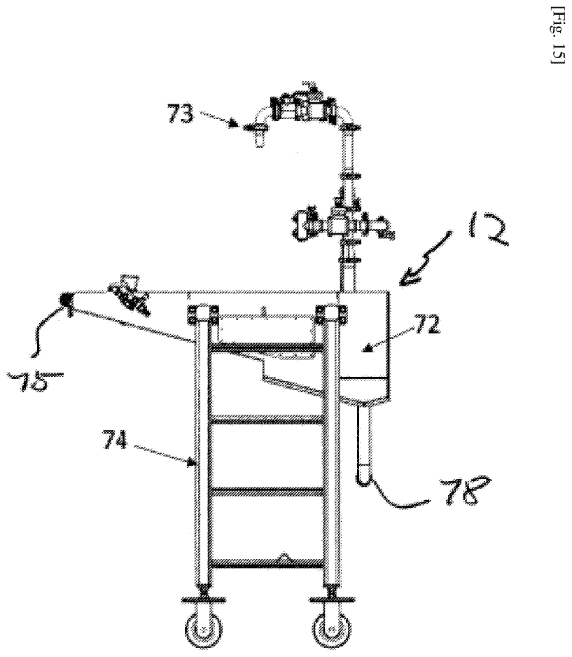

The main tank 71 can optionally have an inverted pyramid shape, as seen in FIGS. 13-15 and 18, so that the washing fluid is directed towards the secondary tank 72 that can be optionally located adjacent to the tank 71. It is appreciated that the shape of the tank 71 can be modified according to the needs of the process of the apparatus of the invention. An extraction means 77, for example a submersible pump (see FIG. 14), can optionally be placed in the secondary tank 72 to lead the fluid that comes from the main tank 71 to the distribution module 73, from where it will be distributed to the apparatus 10. A purging means 78 can optionally be placed at the bottom of the secondary tank 72 to remove solid process debris that has accumulated by settling in the secondary tank 72 (see FIG. 14). The purging means 78 can optionally be connected to a separation tank 91 in the filtering module 13, as discussed below, to start the process of filtration and recirculation of washing fluid to the apparatus 10.

A dispensing element 76 can optionally feed clean replacement fluid into the process (see FIG. 14). The dispensing element 76 can optionally comprise sprinklers, for example fan sprinklers, to deliver the fresh fluid towards the main tank 71.

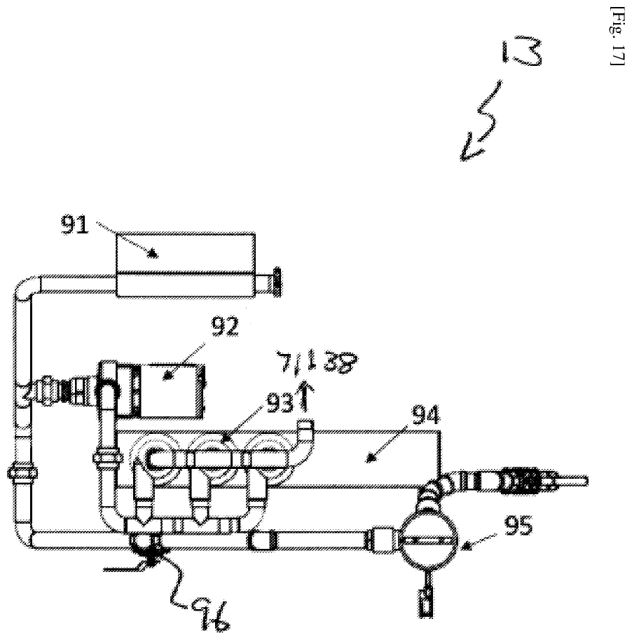

The optional filtering module 13 (see FIGS. 16-17) collects fluid from the secondary tank 72 through the separation tank 91. The separation tank 91 can optionally comprise a settling tank that has internal divisions to separate the fluid from the solid waste that is present in high concentrations and take it to the bottom to extract it from the process, for example by means of a purging means (not shown) such as a valve. The internal divisions of the settling tank also permit drawing fluid with low solids content from the top through the filtering means 92 and causing such drawn fluid to pass through the rest of the filtration steps of the module 13. The filtering means 92 optionally comprises a pump that leads the fluid with low solids content from the settling tank to a plurality of separators 93 that separate suspended solids contained in the fluid for later deposit in a waste tank 94, for example arranged at the outlet of the separators 93. The plurality of separators can optionally comprise at least two hydrocyclones. The waste tank 94 is optionally connected by connection means, for example pipes, to a filter 95, which can optionally be a basket filter. It is appreciated that any other equipment can be used for this purpose, with the goal of filtering the contents of the waste tank 94 and then removing the collected solids through a purging means 96, given that filter 95 is connected to the suction of the filter pump 92. The fluid filtered in the filtration module 13 optionally returns to the tank 71, for example by means of the pump 92. The returned can optionally be returned, for example by means of pump 77, to the apparatus 10 by means of the distribution module 73.

A support structure 74 is provided for supporting the apparatus 10 and all of the structural elements of the apparatus, for example those discussed above (see FIGS. 1-3 and 13-15).

The present invention provides methods of cutting products, washing products or both, for example using apparatus 10.

The method can optionally comprise providing a container with an outlet communicating with a product slicing element, creating a fluid vortex in the container, the vortex having an axis substantially centered on the outlet of the container, and depositing the food product into the container, wherein the fluid vortex aligns the food product with the axis of the vortex and directs the food product into the outlet to the product slicing element to form a plurality of sliced products from the food product. Such method can optionally include any other method step discussed herein.

The method can optionally comprise washing the food product in a first container in a first washing step, slicing the food product to form a plurality of sliced products and washing the sliced products in a second container in a second washing step, wherein the first washing step and the second washing step remove superficial substances, latex, starch and any combination of the foregoing from the food product. Such method can optionally include any other method step discussed herein.

The method can optionally comprise the following steps:

Feeding the product 41 to be cut into the feed and slicing module 11.

To facilitate the process in the case of a food product, the food product can optionally be supplied without the peel and without the ends or tips. The product 41 can optionally be positioned in the feed and slicing module 11 with the longest side thereof parallel to the feed channel 35.

Transporting the fed product to the slicing element 36.

The feed channel 35 sends the product 41 towards the container 2, with the flow of the washing fluid in said channel 35 provided by the distribution module 73, and subsequently sends it towards vortex or swirling or whirling fluid 32 that is formed in the container, for example the conduction means 31 discussed above. Once the product 41 enters the container or hopper 21, the product in entrained or carried by the vortex 32 or tangentially coupled to the vortex 32, constantly changing its position in the vertical-horizontal-tangential directions with respect to the vortex 32. With the help of the fluid flow provided by the distribution module 73, the product arrives at a zone 34, shown in FIG. 11, where it is aligned or placed in a vertical position, or positioned or substantially aligned with the axis of the vortex, before entering the slicing element 36. The vortex optionally tapers inwardly in zone 34. The axis of the vortex in zone 34 is optionally centered on or aligned with outlet 102 of the container 21. The product in zone 34 is optionally substantially perpendicular to the slicing element 36.

Cutting the product 41 in the slicing element 36.

The product 41, having been previously washed in the container 21, for example in the vortex 32, is directed to the slicing element 36 where it is sliced. The washed and cut product can optionally be removed from apparatus 10, for example via an output conveyor, and subjected to further processing steps, for example frying, at this point.

Alternatively, an additional washing of product 41 can optionally be provided, for example to ensure that all undesirable substances have been removed from the surface thereof. The additional or second washing can optionally include removing surface substances from the cut product, for example by immersing the cut product in some suitable fluid contained in tank 71 to obtain a clean cut product. As the product 41 is cut and sent into the tank 71 containing a fluid, the fluid may change color, appearance or both due to the surface substances that are transferred from the cut product. Latex, for example, causes water to turn yellow and oil to turn cloudy. To maintain a clean fluid, the fluid can optionally be replaced, for example periodically or constantly, as determined by the operator. Factors influencing the replacement of the fluid the type of process. In the case of oil, it can be filtered to remove residues of surface substances and can be reused in the process.

Removing the cleaned and cut product.

After the surface substances have been removed in the tank 71 containing a fluid, the product optionally reaches the output conveyor 75, for example due to the eccentric force with which the sliced product is ejected from the slicing element 36 and the deflector 33. The output conveyor 75, in addition to optionally transporting the cut product out of the apparatus 10 towards other possible steps of the process, for example frying, can optionally serve as a filter to separate the slices of clean product from the debris or surface substances that have remained in the fluid. A stream of clean fluid can optionally be supplied through a dispensing element 76 arranged in proximity to the output conveyor 75 to complete the cleaning of the cut product and replenish washing fluid to the apparatus 10. The cut products can be supplied to further processing steps.

Filtering the fluid laden with surface substances and feeding it back to the apparatus 10.

The method and apparatus of the invention can optionally include filtering and recirculating the filtered fluid to the apparatus 10 for further use. The fluid that is in the main tank 71 and that is loaded with the superficial substances that were removed from the cut product can optionally be directed towards the secondary tank 72, from where it can optionally be sent to the separation tank 91 of the filtering module by means of the purging means 78. In the separation tank 91, the solid waste can optionally be filtered from the fluid, and the filtered fluid be conducted by means of the pump 92 towards the plurality of separators 93. The filtered fluid can optionally be subjected to a separation process in the separators 93 to continue eliminating solid waste from the fluid. From the separators, the fluid can optionally be sent to the main tank 71, from where it will be conducted or urged by means of the submersible pump 77 to the distribution module 73. The fluid with waste that reaches the waste tank 94 can optionally undergo another filtration step in the filter 95 to enhance the filtration process, and then be returned to the plurality of separators 93 from where the fluid is sent to the apparatus 10, as described above.

An apparatus for cutting and washing food products of generally elongated shape is provided and can include a container that is coupled at a first end to a feed channel to feed a product to be sliced, a slicing element for slicing the fed product, the slicing element being coupled onto a second end of the container and conduction means for conducting washing fluid towards and inside the container and forming a vortex that positions, pushes the product to be sliced towards the slicing element and performs a first wash.

The container can optionally be a hopper and the coupling of the slicing element with the base can optionally be performed by means of a coupling means that includes bearings and shafts. The apparatus can optionally include a drive means for providing movement to the slicing element and the slicing element can optionally include a slicing disc. The apparatus can optionally include a thrust ring to generate a fluid ring at an angle of inclination, for example between 45° and 80°, in a tangential direction to the flow of the vortex to further direct the product towards the slicing element and a main support structure to support all the elements of the apparatus. The slicing element can optionally include a deflector to direct the sliced product towards an output conveyor. The apparatus can optionally include a tank module comprising a main tank arranged to be adjacent to the slicing element to receive the sliced products and perform a second wash and a secondary tank to distribute the wash fluid throughout the system. The main tank optionally has an inverted pyramid shape. The secondary tank optionally includes extraction means to conduct the fluid that comes from the main tank towards a fluid distribution module, the extraction means optionally including a submersible pump and distribution module optionally including a plurality of pipes that are connected to the conduction means to distribute the washing fluid towards the feed and slicing module. The secondary tank can optionally include a purging means for removing solid waste from the process. The apparatus can optionally include a dispensing element for feeding clean replacement fluid to the system and optionally include sprinklers. The apparatus can optionally include a tank module, comprising a main tank arranged adjacent to the slicing element to receive the sliced products and perform a second wash and a secondary tank to distribute the wash fluid throughout the system, and a filtering module to filter the washing fluid and feed it back to the system and optionally comprising a separation tank, filtering means and a plurality of separators. The separation tank of the filtering module can optionally include a settling tank and a purging means to extract solids from the system, and the settling tank having internal divisions to separate solid waste present in high concentrations in the washing fluid. The filtering means can optionally include a pump for driving the washing fluid with a low solid content from the settling tank to the plurality of separators, the plurality of separators optionally comprising at least two hydrocyclones. The apparatus can optionally include a waste tank arranged at the outlet of the plurality of separators to contain suspended solids that have been separated from the washing fluid in the plurality of separators. The apparatus can optionally include a filter connected to the waste tank to filter the contents of said waste tank and remove the solids collected by the system by means of a purging means, the filter optionally comprising a basket filter.

A method of cutting and washing food products of generally elongated shape is provided and includes feeding a product to be cut through a feed channel, passing a flow of fluid through the feed channel to send the product towards a hopper where a vortex is formed, washing and directing the product towards the slicing element by means of the vortex, transporting the fed product to a slicing element where it is sliced, the direction of transport optionally being horizontal with flow towards the right or the left, vertical with upward or downward flow, or inclined with upward or downward flow, cutting the product by passing it through the slicing element in a direction that can be horizontal with a rightward or leftward flow, vertical with upward or downward flow, or inclined with upward or downward flow.

The method can optionally include the steps of washing the cut product to remove surface substances by immersing the cut product a suitable fluid contained in a main tank to obtain a clean cut product and removing the cleaned and sliced product, for example by means of an output conveyor. The method can optionally include the step of supplying clean fluid to the cleaned and cut product to clean it and replenishing washing fluid to the system, for example by means of a dispensing element. The method can optionally include the step of filtering the fluid laden with superficial substances from the product in a filtering module and feeding said filtered fluid back to the system. The purpose of the method can optionally be to remove superficial substances from the product, including for example latex and starch. The fluid contained in the tank can optionally be water, oil or a combination of both. The products can optionally be of generally elongated shape, and can optionally comprise fruits, vegetables, bananas, cucumbers, squash, carrots, cassava, sweet potato, taro or malanga.

The method and apparatus of the invention provide an efficient system for cutting and removing surface substances from the product being processed. As a result of such removal, the product will not stick to the walls of the processing equipment or to the hands of the personnel who handle it. The processed product is provided with an excellent presentation for final consumption. The system of the invention avoids the use of chemical additives used to remove said substances.

The apparatus and method of the invention are simple, efficient, and economical, and allow for the effective removal of surface substances from the cut products. Such surface substances can optionally include any substances that is undesirable during the processing of the product, for example latex or starch in the case of cutting food products such as fruits or vegetables, limiting the use of special chemical products for the removal of said substances.

The apparatus and method of the invention facilitate the handling and processing of the cut products by delivering clean products, for example free of surface substances, that do not stick to the walls of processing equipment or to the hands of the personnel handling them, also giving clean products excellent presentation for final consumption.

A person skilled in the art can envisage modifications in the invention described herein. However, it should be noted that this description relates to preferred embodiments of the invention and is provided for illustrative purposes only, and should not be understood as limiting the invention. All obvious modifications in the spirit of the invention, such as changes in the shape, material, and dimensions of the elements that make up the invention, should be considered within the scope of the attached claims.

1. A method of cutting a generally elongated food product, comprising providing a container with an outlet communicating with a product slicing element, creating a fluid vortex in the container, the vortex having an axis, and depositing the generally elongated food product into the container, wherein the fluid vortex aligns the generally elongated food product with the axis of the vortex and directs the generally elongated food product into the outlet to the product slicing element to form a plurality of sliced products from the generally elongate food product.

2. The method of claim 1, wherein the providing step comprises providing a cylindrical container.

3. The method of claim 1, wherein the creating step comprises creating a vortex with a portion that tapers inwardly towards the outlet.

4. The method of claim 1, further comprising introducing a washing fluid into the container so that the food product is washed by the fluid vortex.

5. The method of claim 4, wherein the sliced products are washed in an additional washing process.

6. The method of claim 5, wherein the additional washing process includes immersing the sliced products in an additional container having washing fluid to provide cleaned sliced products and used washing fluid.

7. The method of claim 6, further comprising removing the used washing fluid from the additional container, removing suspended solids from the used washing fluid to provide clean washing fluid and directing the clean washing fluid to the additional container.

8. The method of claim 7, further comprising directing the clean washing fluid to the container.

9. The method of claim 4, wherein the washing fluid removes superficial substances, latex, starch and any combination of the foregoing from the food product.

10. The method of claim 9 wherein the washing fluid is selected from the group consisting of water, oil and both.

11. The method of claim 1, wherein the food product is selected from the group consisting of fruit, vegetables, bananas, cucumbers, squash, carrots, cassava, sweet potato, taro and malanga.

12. A method of cutting and cleaning a food product, comprising washing the food product in a first container in a first washing step, slicing the food product to form a plurality of sliced products and washing the sliced products in a second container in a second washing step, wherein the first washing step includes constantly changing the position of the food product in a swirling fluid, wherein the first washing step and the second washing step remove superficial substances, latex, starch and any combination of the foregoing from the food product.

13. The method of claim 12, wherein the first washing step includes swirling the food product in the swirling fluid of the first container.

14. The method of claim 13, wherein the first washing step includes immersing the food product in a vortex having a portion that tapers inwardly to facilitate slicing of the food product.

15. The method of claim 12, wherein the second washing step includes immersing the sliced products in the second container of a washing fluid to provide cleaned sliced products and used washing fluid.

16. The method of claim 15, further comprising removing the used washing fluid from the second container, removing suspended solids from the used washing fluid to provide clean washing fluid and directing the clean washing fluid into the second container.

17. An apparatus for cutting a generally elongated food product, comprising a container having a periphery and an outlet, a product slicing element communicating with the outlet of the container, the container having a plurality of fluid jet ports spaced around its periphery for forming a fluid vortex in the container having an axis, wherein the fluid vortex aligns the generally elongated food product with the axis of the vortex and directs the generally elongated food product into the outlet to the product slicing element to form a plurality of sliced products from the food product.

18. The apparatus of claim 17, wherein the container has a diameter and the plurality of fluid jet ports are each directed substantially perpendicular to the diameter of the container.

19. The apparatus of claim 18, wherein the plurality of fluid jet ports are each additionally directed towards the outlet of the container.

20. The apparatus of claim 17, wherein the container has a portion that tapers inwardly towards the outlet.

21. The apparatus of claim 17, wherein the container has a washing fluid inlet port for providing washing fluid to the vortex to wash the food product within the vortex.

22. The apparatus of claim 21, further comprising an additional container for receiving the sliced products and immersing the sliced products in a washing fluid for additional washing.

23. The apparatus of claim 21, further comprising a recirculation system coupled to the outlet and the washing fluid inlet port for removing solid process debris from the washing fluid received from the outlet to provide clean washing fluid and delivering the clean washing fluid to the washing fluid inlet port for reuse in the container.

24. The apparatus of claim 17, where in the container has a plurality of fluid jet ports spaced around its periphery for forming a fluid vortex in the container that tapers inwardly towards the outlet.
